(19) United States
(12) Patent Application Publication
(10) Pub. No.: US 2004/0094641 A1
(43) Pub. Date: May 20, 2004

(54) Method and apparatus for the processing of used tires and other materials

(76) Inventor: Christopher Chen, London (CA)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/065,776

(22) Filed: Nov. 18, 2002

(51) Int. Cl. B02C 19/12

(52) U.S. Cl. 241/19; 241/23; 241/65

(57) ABSTRACT

A method and apparatus for breaking down pieces of material into smaller pieces and for separating out different substances making up the material, one of the substances being a fibrous textile and another being metal, comprising the steps of subjecting the pieces to a series of dismemberments to produce progressively smaller pieces falling within a predetermined size range; separating the smaller pieces into a plurality of fractions, each fraction including pieces within a predetermined size range; and subjecting each fraction to a flow of air calibrated to cause separation of the fibrous textile material from the pieces.

### BACKGROUND OF INVENTION

The present invention relates to recycling and more particularly to the processing of worn rubber tires, both in order to avoid the disposal of the same as garbage, and in order to enable the recycling of the materials of the tire. The technology as described herein is not however limited in its applicability only to tires, but may encompass the processing of other items that contain different materials that are difficult to separate by conventional methods.

Automotive tires include in their structure the bulk rubber of the treads and sidewalls, the butyl rubber lining on the inside of the tire, steel wires arranged as plies or layers embedded in the rubber carcass, hardened steel wire in the bead or rim of the tire and fiber cords also usually arranged in plies or layers. The materials, and particularly the rubber and steel, have value as material suitable for recycling into fresh products, but only if the materials can be well separated from each other.

The ruber from used tires, particularly when ground into small granules called crumb rubber, has good recycle value, primarily however if the crumb is relatively pure and free of pieces of fiber and metal.

The conventional technologies for breaking down used tires are of two types, namely shredding and hammering. In the shredding or cutting processes, the tire is chopped into progressively smaller pieces by heavy duty knife blades. Shredding by itself however is incapable itself of reducing the crumb to ultra-fine fractions which command the highest prices from recyclers. The shredding itself moreover does not separate the tire into different materials, and separation requires further processing which is effective to a point, but existing technology still leaves behind significant metal and fiber fractions.

To overcome these shortcomings, the shredding processes have been taken further to combine granulating. This involves chopping the tires into smaller and smaller chips. The chips are screened between stages as to size, and pass through magnetic separators, cyclones and so forth for separation of the metal and fiber from the rubber.

In conventional hammering or flailing processes, the tire is cut into chips and frozen down to cryogenic temperatures by immersing the chips in liquid nitrogen. The rubber becomes brittle at these temperatures, and the rubber will crack and break up when subjected to hammering. Continued pounding of the pieces of frozen tire by hammers can lead to further size reductions and material separation, but existing technology limits size reduction and materials separation.

### SUMMARY OF INVENTION

The present invention consists of a method and apparatus for breaking down pieces of material such as old tires. The invention moreover is for use with materials of the kind which become brittle at cryogenic temperatures.

The apparatus includes two subsystems. The first is an ambient grinding subsystem that physically reduces the whole car and truck tires to crumb rubber of 4-20 mesh size at ambient temperatures and pressures. This subsystem includes several extraction points for removing both steel and fiber. The extracted steel is clean and substantially free of rubber and fiber and is therefore itself a valuable recyclable commodity particularly for steel mills, and provides added economic benefit to the system. The second major subsystem is a cryogenic grinding subsystem that uses multiple stages of pre-freezing, freezing and post-freezing processing to reduce the rubber to 40-200 mesh crumb.

The cryogenic grind subsystem reduces crumb rubber temperatures from ambient to as low as −196 C by utilizing liquid and vaporous nitrogen. The crumb rubber temperature is adjustable depending on the in-feed materials and required end products. The system incorporates pre-freezing, freezing and post-freezing into one system to make maximum utilization of the coldness of the liquid nitrogen.

Following cryogenic grinding, the crumb is classified by sifting it for mechanical separation of the crumb according to particle size. Typically, the crumb is separated into 40-60, 60-80, 80-100 and 100 mesh minus sizes. The separated classifications are then bagged for shipment. In a preferred embodiment, additional metal and fibrous separation steps are incorporated into the bagging subsystem to remove more of these byproducts from the crumb.

It is therefore an object of the present invention to provide an improved system for processing used tires to produce recyclable commodities having high commercial value.

It is a further object of the present invention to provide a processing system that maximizes the recovery of recyclable products produced by the system.

It is yet another object of the present invention to provide a processing system which can yield higher fractions of fine and ultra fine mesh crumb to maximize revenue.

According to the present invention then, there is provided a method for breaking down pieces of material into smaller pieces and for separating out different substances making up said material, one of said substances being a fibrous textile and another being metal, comprising the steps of subjecting said pieces to a series of dismemberments to produce progressively smaller pieces falling within a predetermined size range; separating said smaller pieces into a plurality of fractions, each fraction including pieces within a predetermined size range; and subjecting each said fraction to a flow of air calibrated to cause separation of said fibrous textile material from said pieces.

According to a further aspect of the present invention, there is also provided an apparatus for processing a feedstock consisting of a first material comprising particles of different sizes mixed with a second lighter material to be separated from said first material, comprising means for separating said feedstock into two or more fractions, each said fraction including particles of said first material falling within a predetermined size range; an enclosure for receiving one of each said fractions in a stream passing therethrough; ventilator means causing a flow of air to intersect said stream of particles in said enclosure; and means for adjusting the flow rate of said air having regard to said size range of said particles, wherein said airflow carries away some or all of said second material for separation from said first material.

According to yet another aspect of the present invention, there is provided a method of treating a particulate material cryogenically to produce smaller particles, comprising the steps of cooling said material to cryogenic temperatures; feeding said cooled material at a predetermined rate between at least one pair of closely spaced, counter-rotating rollers for reducing the size of said particles, one roller of said pair rotating at a first predetermined speed, and the second of said rollers rotating at a second higher predetermined speed; and thereafter subjecting said material to hammering for producing yet smaller particles.

According to a yet further aspect of the present invention, there is also provided an apparatus for treating a particulate material cryogenically to produce smaller particles, comprising freezer means wherein said material is cooled to cryogenic temperatures; at least a first pair of closely spaced apart, counter-rotating rollers sealed in a housing for receiving said cooled material therebetween for a first reduction in the size of said particles; means for driving each roller of said pair at a selected, predetermined rotational speed; and means for receiving and storing-said material following said cryogenic treatment thereof between said rollers.

According to yet another aspect of the present invention, there is also provided a method of sorting a material into separate fractions, each fraction including particulates of said material falling within a predetermined size range, comprising the steps of adding a flow agent to said material and mixing said material and said flow agent together, said flow agent being selected to increase the recovery of the smallest particles of said material; sorting said material through a plurality of screens to cut said material into said fractions; and collecting said fractions for packaging or storage.

### BRIEF DESCRIPTION OF DRAWINGS

The invention will now be described in greater detail and will be better understood when read in conjunction with the following drawings, in which:

FIG. 1 is a plan schematical view of the ambient grinding subsystem of the present invention.

FIG. 2 is a side elevational schematic view of a portion of the system using raspers.

FIG. 3 is a side elevational schematic view of a first shaker table forming part of the subsystem.

FIG. 4 is an elevational schematic view of a portion of the subsystem for metal separation.

FIG. 5 is an elevational schematic view of a further portion of the subsystem for storage and chopping of the rubber.

FIG. 6 is an elevational schematic view of a further portion of the subsystem including a second shaker table.

FIG. 7 is a side elevational schematic view of a third shaker table.

FIG. 8 is an elevational schematic view of a further portion of the subsystem including a fourth shake and showing the discharge of crumb from the fourth shaker into an aspirator.

FIG. 9 is a side elevational schematic view of the aspirator.

FIG. 10 in a plan schematical view of the cryogenic grinding subsystem of the present invention.

FIG. 11 is a side elevational schematic view of a portion of the subsystem.

FIG. 12 is a side elevational view of the freezer and cryogenic grinder systems of the present invention.

FIG. 13 is a partially sectional, schematical elevational view of a grinding module.

FIG. 14 is a side elevational view of a grinding module connected to a hammer mill forming part of the subsystem.

FIG. 15 is a plan view of a grinding module.

FIG. 16 is an elevational view of a fast roller forming part of the grinding module.

FIG. 17 is an end elevational view of the roller of FIG. 16.

FIG. 18 is a side elevational view of a slow roller forming part of the grinding module.

FIG. 19 is an end view of the roller of FIG. 18.

FIG. 20 is a side elevational schematic view of the hammer mill and additional storage forming part of the subsystem.

FIG. 21 is a side elevational, schematic view of the classification portion of the present system.

FIG. 22 is a partially sectional, side elevational schematic view of a sifter forming part of the classification system.

FIG. 23 is a schematical view of a bagging station for packaging crumb rubber.

### DETAILED DESCRIPTION

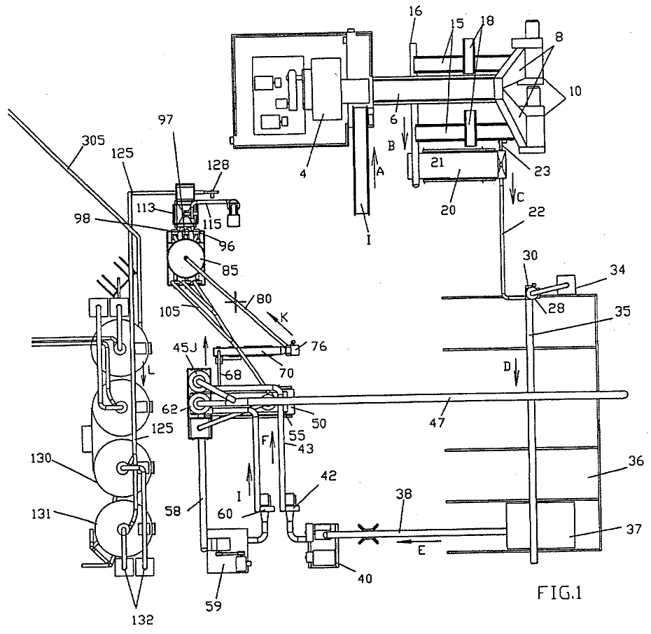

Reference will initially be made to FIG. 1 showing in plan view the ambient grinding subsystem used to physically reduce whole car and truck tires, or portions thereof, into 4-20 mesh size pieces and to remove most of the fiber and metal from the rubber prior to cryogenic grinding.

The word “tire” will be used to denote both complete tires and tire pieces. The pieces may be the tire tread or the sidewalls or simply chunks of tire including both tread and sidewall. There can be slight differences between the processing of tire treads as opposed to sidewalls, particularly as treads incorporate relatively little fiber, but these processing differences are relatively minor and the process is largely the same regardless of the feed stock.

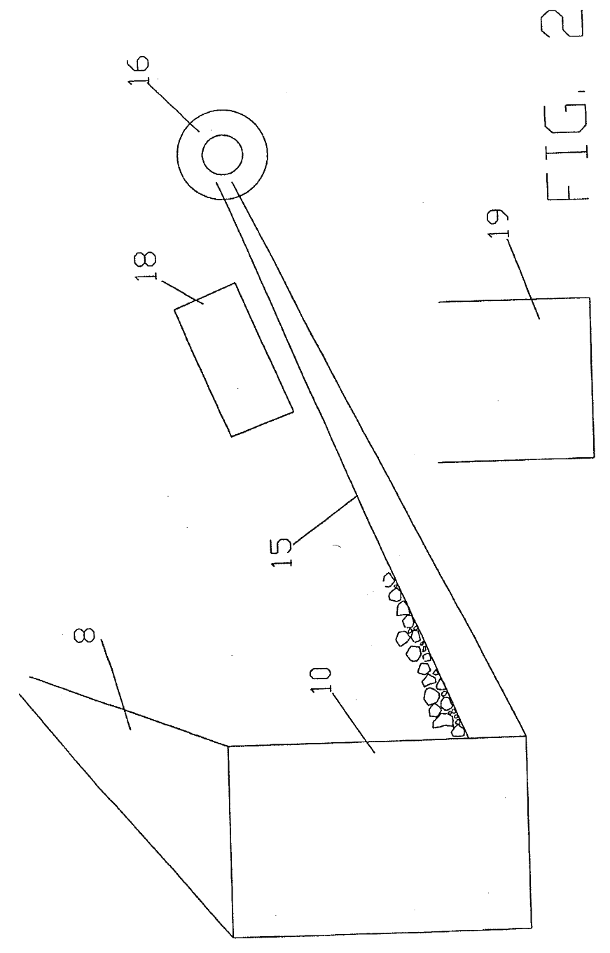

The tires (not shown) are initially loaded onto a conveyor 1 that transports them in the direction of arrow A into a shredder 4. The shredder, for example a Reduction Tech Shredder model MS-5040, includes an internal screen that passes chips up to two inches in size onto conveyor 6 which can be 36 inches in width. Chips larger than two inches are held in the shredder until they are small enough to fall through the screen onto conveyor 6. Conveyor 6 delivers the chips to a manifold 8 seen most clearly in FIGS. 1 and 2 that divides the chips into two approximately equal streams that fall by gravity through the manifold into a pair of commercially available raspers 10 (Eldan Raspers model 1200-1).

Raspers 10 chop the chips into smaller pieces typically ⅜ of an inch to ⅝ inch in diameter. The output of each rasper is fed to an associated conveyor 15 that carries the chips upwardly for discharge into a transport auger 16 (e.g. 9″) that moves the chips in the direction of arrow B. The raspers liberate a significant amount of steel and with reference particularly to FIG. 2, this steel is removed using belt magnets 18 located above each of conveyors 15. The magnets are rotating endless belts that pick up the steel that is subsequently scraped off to fall into storage bins 19 located beneath the magnets. When full, the bins are wheeled away and replaced by empty containers.

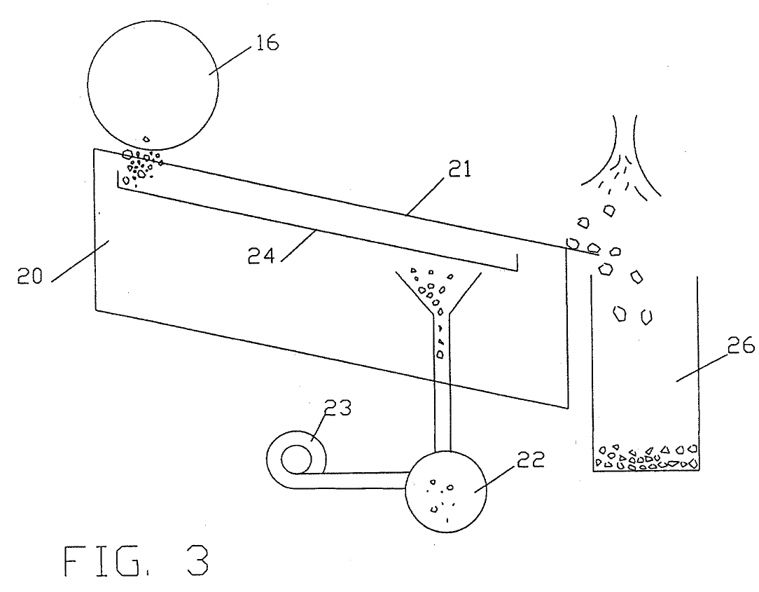

The output of auger 16 is discharged onto vibrating shaker table 20 (available from Dillon). Shown schematically in FIG. 3, the shaker's upper surface 21 is a vibrating screen of approximately ½ inch mesh. Chips of less than ½ inch fall through the screen and discharge onto deck 24 and then into pneumatic conveyor 22 where they are blown by a blower 23 in the direction of arrow C for further processing as will be described below. Chips greater than ½ inch in size, as well as liberated fiber, remain on top of the shaker's screen where they vibrate downwardly towards the screen's lower end. The fiber is skimmed or suctioned off, and the oversize chips discharge into a hopper 26 for manual (or mechanical) recycling back to raspers 10 for further reduction.

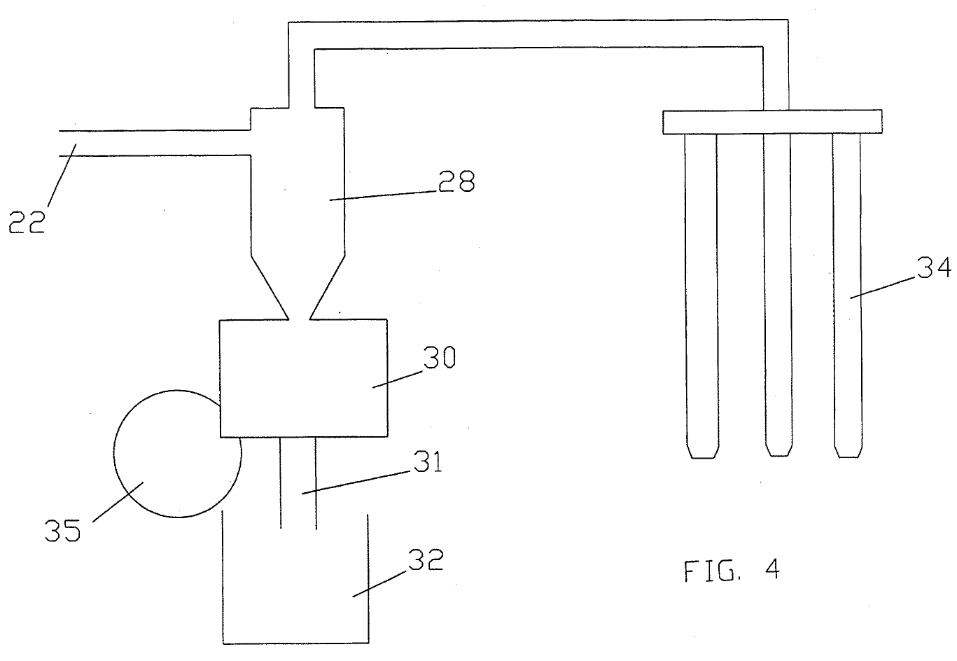

Pneumatic conveyor 22, which is essentially a hollow duct of tubing, extends from shaker table 20 to discharge its load into a cyclone 28 shown schematically in FIG. 4 where the velocity of the load is reduced. The chips fall into a rotating drum magnet 30 (for example a 12 inch ERIEZ drum magnet) which spins out steel for discharge through pipe 31 into bag 32 for collection. The rubber itself is discharged into another auger 35 (9″) for transport in the direction of arrow D. Cyclone 28 communicates with a bag-type manifold 37 that dissipates the airflow from blower 23.

With reference to FIG. 5, auger 35 is located above a series of storage bins 36.

The auger includes a gate above each bin for discharge of the crumb into a one or more of the bins. Ideally each bin, or at least one of the bins, includes a hopper 37 to receive the rubber. The hopper discharges the crumb into an auger 38 (9″) that transports the crumb in the direction of arrow E to a chopper 40 that further reduces the crumb to pieces approximately 5/16 inch in diameter.

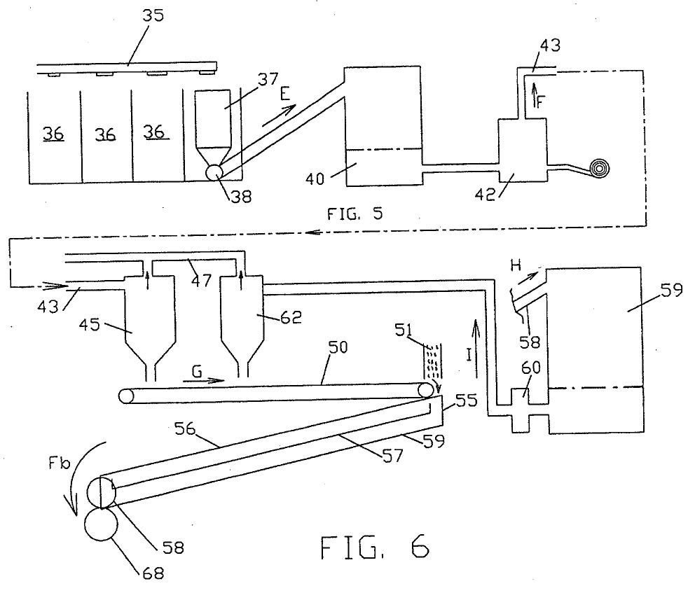

Chopper 40 includes an internal screen that passes 5/16 inch pieces or smaller, and retains the larger pieces until sufficiently reduced. A suction blower 42 is used to draw out the chopper's output and then push the rubber in the direction of arrow F through duct 43 into cyclone 45 as shown most clearly in FIG. 6. The airflow from the cyclone is exhausted through duct 47 while the crumb gravity-discharges onto belt conveyor 50 (e.g. 16″). Conveyor 50 transports the crumb in the direction of arrow G where the crumb is discharged onto the intake of an inclined vibrating screener (which can be another Dillon shaker) 55. A suction line 51 at the end of conveyor 50 draws off accumulated fiber.

Screener 55 has at least two screens, namely a top deck 56 and a lower screen 57. All the rubber falls through the top deck, leaving behind fiber which balls up with the vibration and eventually falls off the end of the deck in the direction of arrow F_{b} where it is collected into bins or bags for disposal. The rubber falling onto vibrating screen 57 is sorted into oversize and undersize fractions. The oversize remains on top of the screen and discharges into auger 58 for transport in the direction of arrow H into another chopping machine 59 such as a Reduction Tech Knife Hogg. Chopper 59 reduces the oversize crumb to ¼ inch to 5/16 inch pieces and a second suction blower 60 is used to deliver this material in the direction of arrow I to cyclone 62 as shown in FIG. 6. Cyclone 62 discharges onto conveyor 50 and this output mingles with the output of cyclone 45 to complete a loop that ensures sufficient reduction of all crumb delivered to screener 55.

The undersized fraction falling through vibrating screen 57 collects on lower tray 58 and eventually discharges into an auger 68 (e.g. 4″) that delivers the crumb in the direction of arrow J to another vibrating shaker table 70 (e.g. LMC Shaker). At this point, the crumb should all be 4 mesh or smaller.

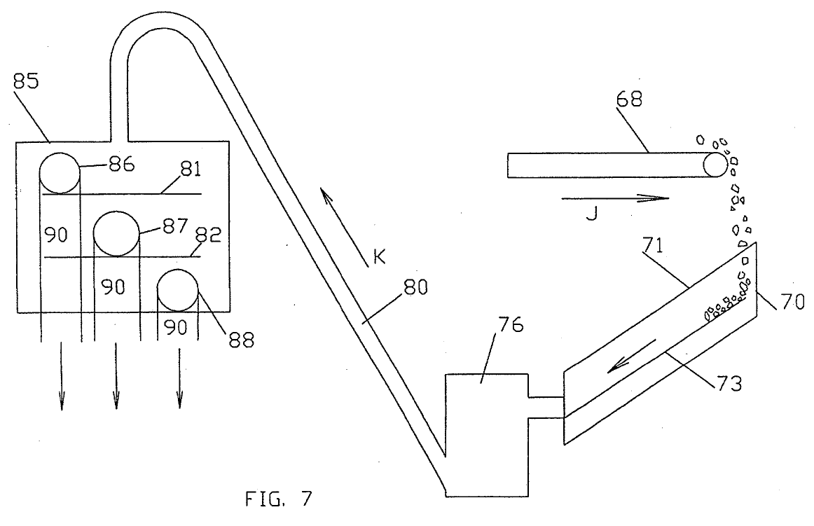

Shaker 70 is shown schematically in FIG. 7 and again includes two vibrating layers, an upper screen 71 that allows the rubber to fall through but which collects and then discharges more of the remaining fiber and a lower deck 73 that receives the rubber and entrained metal. Lower deck 73 discharges its load into a rotating drum magnet 76 (ERIEZ) which spins out and extracts steel while discharging the rubber into auger 80 (6″). Auger 80 transports the rubber in the direction of arrow K to the top of yet another shaker 85 which in this instance is a unit manufactured by KASON.

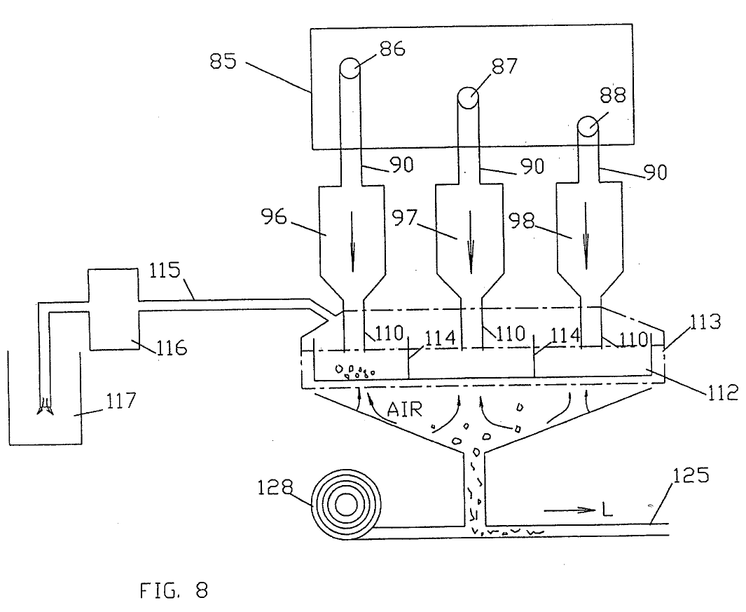

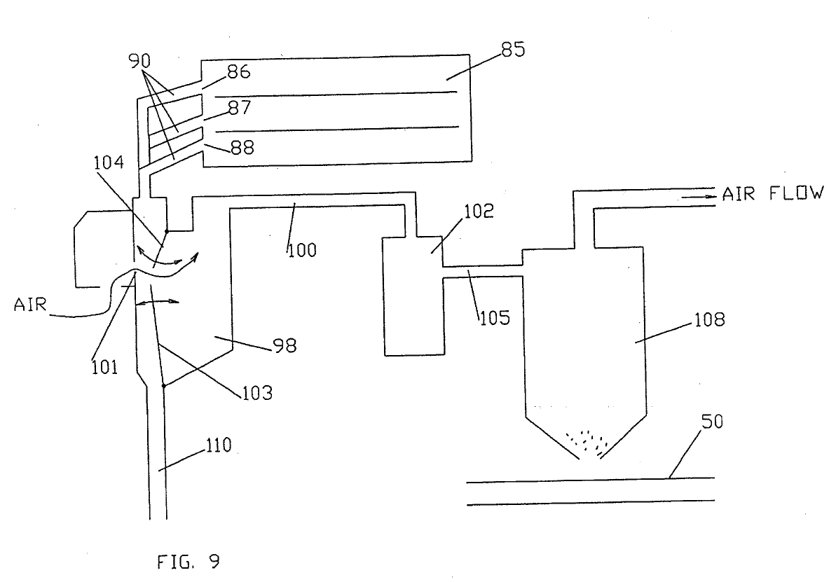

Shaker 85 cuts the crumb into three fractions using two screens. The first screen passes everything less than 10 mesh and the second screen passes everything less than 20 mesh. The three fractions are therefore 4-10 mesh, 10-20 mesh and less than 20 mesh. Each fraction is discharged from shaker 85 through a separate outlet into a respective aspirator where each fraction is subjected to a cross flow of air carefully calibrated depending upon fraction size to blow away particles of fiber without also blowing away significant quantities of rubber. This process will now be described in greater detail with reference to FIGS. 8 and 9.

Shaker 85 discharges the three fractions through outlets 86, 87 and 88 through ducts 90 into respective aspirators 96, 97 and 98. Each aspirator is connected by a manifold 100 (FIG. 9) to a suction blower 102 (2 HP), preferably one blower per aspirator, which sets up a cross flow of air in the aspirators by drawing clean air in to each aspirator through an inlet 101 as indicated by the arrow marked AIR. Inside each aspirator is a pair of adjustable valves or dampers 103 and 104 used to control the velocity of the airflow. The object of course is to draw off the fiber without also drawing off the rubber in a “wheat from the chaff” operation. As will be appreciated, the smaller the crumb fraction, the lower the airflow. The separated fiber drawn through manifolds 100 and blowers 102 is then recycled through ducts 105 (FIG. 1) to a cyclone 108 which discharges this material onto conveyor 50 and then onto screener 55. Although returning the fiber to the screener 55 seems self-defeating, the applicant has discovered that the material combines with the fiber from choppers 40 and 59 and results in more effective clumping or balling of the fiber for better overall extraction. There is the added benefit as well that any rubber entrained with the fiber from the aspirators in recaptured.

The crumb that passes through the aspirators discharges through ducts 110 onto a vibrating air table 112 enclosed by a housing such as a metal manifold 113. Dividers 114 on the air table maintain the fractions separately so that calibrated air can be passed through the table from its underside into the crumb. This airflow cushions the rubber and results in tufting of remaining fiber. The fiber becomes airborne and is then drawn out of the manifold through a suction line 15, a suction blower 116 and collects in a bin or bag 117 for disposal. Manifold 113 includes an opening in its front surface through which the three crumb fractions are discharged and blend into a pneumatic conveyor 125 for transport in the direction of arrow L into bins 130 and 131 where the crumb is stored prior to treatment in the cryogenic grinding stage. A blower 128 moves the crumb through duct 125, the blower's airflow ultimately being dissipated by bag manifolds 132.

This completes the ambient grinding stage.

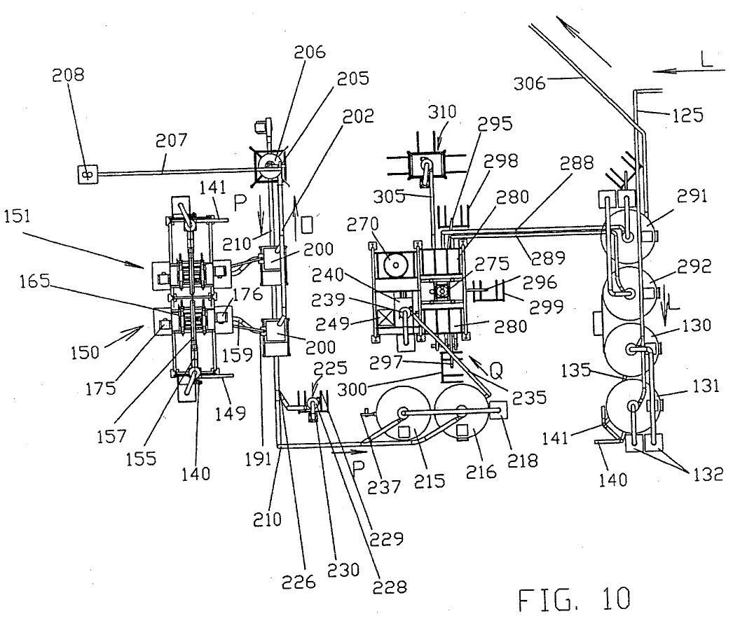

Reference will now be made to FIG. 10 which is a plan view of the cryogenic subsystem of the present process and to the subsequent figures which illustrate, in combination with FIG. 10, different steps in this half of the process.

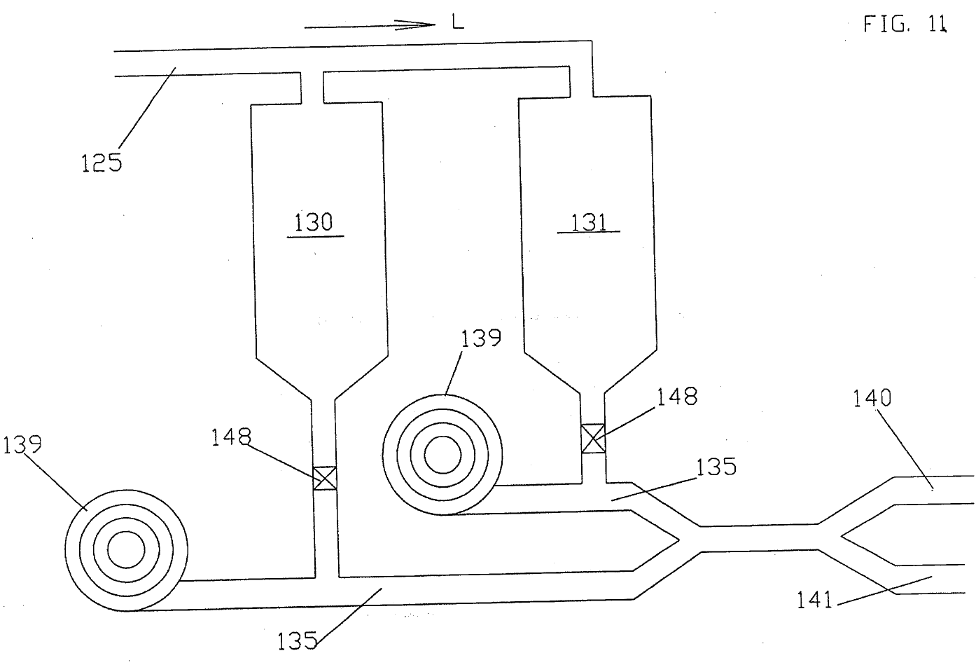

Considering FIGS. 10 and 11, the crumb rubber stored in bins 130 and 131 discharges into pneumatic ducts 135 in which the crumb is propelled by blowers 139. Ducts 135 merge together to combine the discharge of the two bins, and the duct then redivides into conduits 140 and 141 for independent delivery of the crumb to cryogenic grinding stations 150 and 151, respectively. As the processing at each station is essentially the same, the process will be described with respect to one of the stations only.

With reference to FIG. 12, the crumb from conduit 140 discharges into cyclone 146 and from the cyclone into a hopper 149. The hopper includes a sensor 151 that regulates the level of rubber in the hopper. The sensor actuates valves 148 in the discharge from each of bins 130 and 131 (FIG. 11) to maintain the level of rubber in the hopper at a relatively constant level. This assists in metering the flow of rubber from hopper 149 into a freezing unit 155 where the rubber is immersed in liquid nitrogen for cryogenic freezing. The flow of rubber is metered for a controlled rate of addition of the rubber to ensure that uniform freezing of the crumb rubber particles and to avoid inefficiently flashing off the liquid nitrogen by too rapid an in-feed of the crumb.

More specifically, hopper 149 discharges the metered flow of rubber into an auger 152 for transport in the direction of arrow K into freezing unit 155 which is partially filled with liquid nitrogen for cryogenic freezing of the rubber down to a temperature of −196° C. Freezer 155 discharges the frozen rubber from its lower end into auger 157, which preferably is a stainless steel unit specifically adapted for the processing of cryogenic material, for delivery of the material to cryogenic grinding station 150 which includes grinding unit 165. The frozen crumb is then ground between pairs of counter-rotating rollers sealed inside the grinding unit as will be described in greater detail below.

Liquid nitrogen is delivered to freezer 155 through a pressurized (positive or negative) insulated supply line 153 that leads in from a refillable supply tank (not shown) normally located in an exterior location. The supply line includes a valve 154 actuated by a temperature sensor 156 located at a predetermined height on one of the freezer's walls. If the sensor is submerged and detects a temperature of −196° C. or lower, valve 154 is closed, and conversely, if the sensor is not submerged and detects a temperature above this level, the valve is opened for the ingress of additional N₂ liquid. The level of the nitrogen liquid is maintained below the top of the freezer so that only a portion of the rubber in the freezer is submerged. The portion of rubber above the liquid level is pre-cooled by the N₂ gas that vaporizes from the liquid as the crumb is cooled. This pre-cooling has been found to reduce total liquid nitrogen requirements.

The nitrogen gas released by the freezer is collected in an insulated line 158 for delivery to grinding unit 165 where it is used for additional post-cooling of the crumb during grinding.

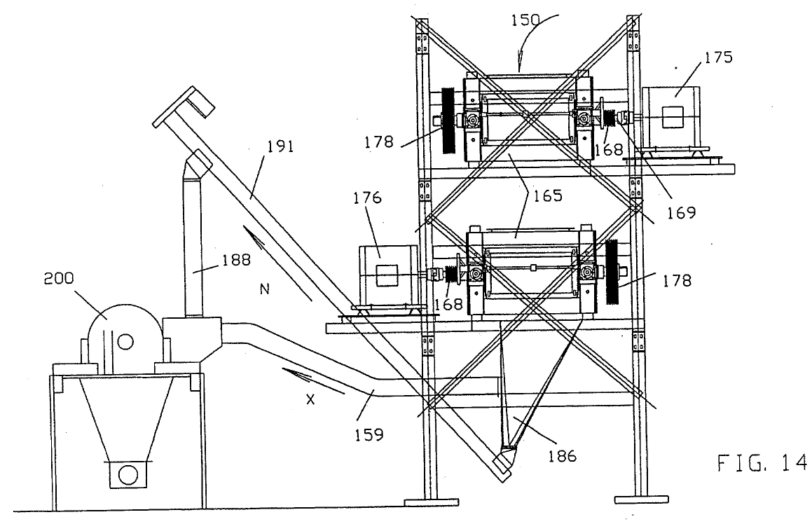

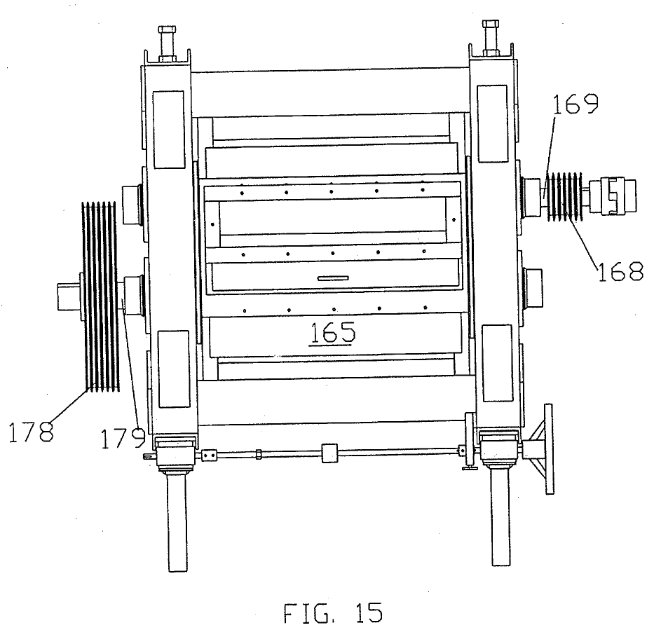

With continued reference to FIG. 12, it will be appreciated that the level of nitrogen liquid shown by a broken line in auger 157 is hydrostatically the same as that in freezer 155. This prolongs the exposure of the crumb to nitrogen liquid and this can be used to determine the optimum level of nitrogen liquid in the freezer to maximize freezing while minimizing nitrogen consumption. The discharge of auger 157 into grinder unit 165 includes frozen rubber, nitrogen gas and possibly small amounts of nitrogen liquid that quickly vaporizes. The applicant has found it advantageous to draw off accumulated cold gas from the bottom of the grinding unit into exhaust line 159 (FIG. 14) for transport in the direction of arrow X for delivery to a hammer mill 200 downstream of the grinding unit as will be described in greater detail below. The hammer mill is for additional reduction of the crumb and the N₂ gas is used to maintain grinding efficiency within the mill which works best at cryogenic levels. In an embodiment constructed by the applicant, freezer 155 has an output of up to 2500 lbs. of rubber per hour.

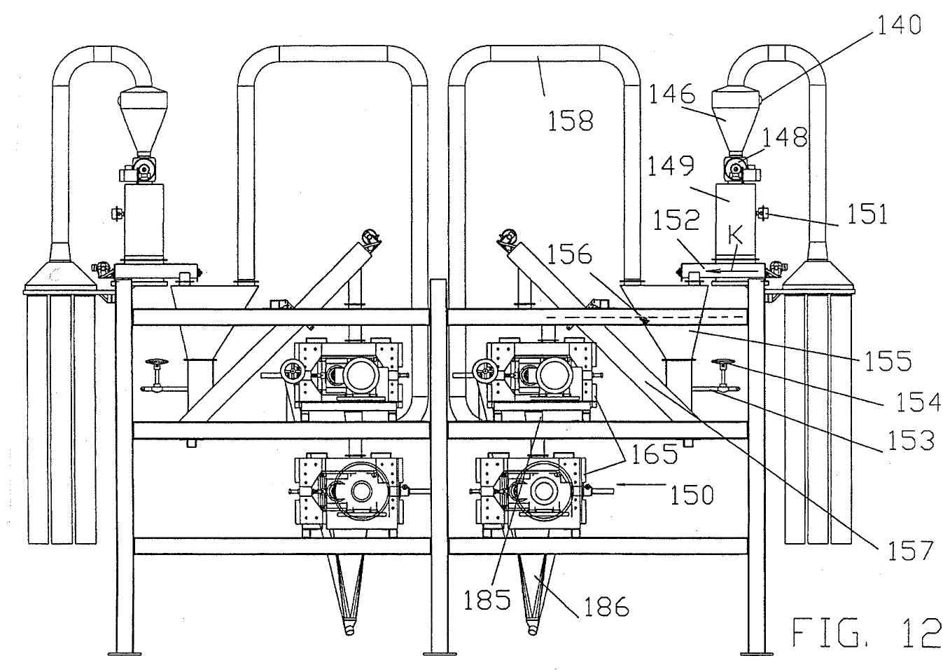

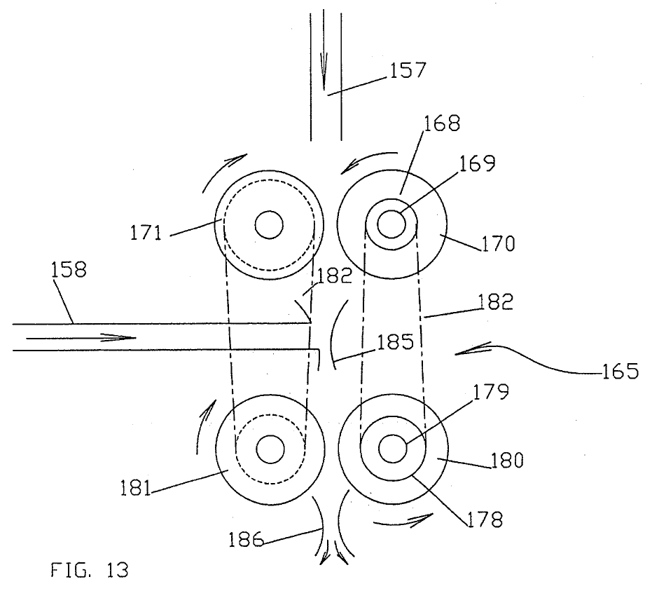

Reference will now be made to FIG. 13 which shows a grinding unit 165 schematically for greater clarity.

The crumb discharged from auger 157 falls between a first upper pair of counter-rotating grinding rollers 170 and 171 and then between a second lower pair of counter-rotating rollers 180 and 181. The gap between each pair of rollers is carefully maintained in the range between 0.002″ and 0.007″ depending upon the type of rubber being ground and the final mesh size required. Advantageously the gap is independently adjustable from each end of the roller pair so that the gap can be maintained at a constant distance despite for example uneven wear rates across the roller surfaces from end to end. Alternatively, the gap can in fact be set to either widen or narrow from end to end.

The rollers of each pair are driven at different rotational speeds. In one embodiment constructed by the applicant, roller 170 and diagonally opposite roller 181 are driven at a rate of 2300 rpm (the fast rollers), while roller 171 and diagonally opposite roller 180 are rotated at a speed of 700 rpm (the slow rollers). As the crumb passes between the roller pairs, the individual particles are therefore subject to both compressive and shearing forces to maximize reduction due to grinding. As well, the relatively high rotational speeds of the rollers ensures that the particles dwell for only a very short time in the grinding zone between the rollers. This minimizes the generation of heat which in turn minimizes the temperature increase of the nitrogen gas in the grinders to reduce overall liquid nitrogen consumption.

There are two drive motors 175 and 176 for the rollers seen most clearly in the view of FIG. 14. Drive motor 175 is mechanically coupled directly to the shaft 169 of roller 170 for rotation of the roller at the aforesaid rate of approximately 2300 rpm. A metal sheave 168 on shaft 169 is vertically aligned with a larger metal sheave 178 on the shaft 179 of roller 180, and a belt 182 shown in phantom lines interconnects the two for simultaneous counterclockwise rotation. The diameters of the two sheaves are selected to provide an approximate 3.5:1 drive reduction between the 2300 rpm rotational speed of the upper roller and the 700 rpm speed of the lower roller. The aforementioned rotational speeds are intended to be exemplary and other speed differentials are contemplated in the range, for example, of 1.1:1 to 10:1 or even higher. The applicant has however obtained good results with roller speed differentials in the 3 to 4:1 range. The rollers may also rotate at equal speeds if shearing of the particles is not required or desired.

On the opposite side of the grinding unit, drive motor 176 is directly coupled to lower roller 181. This roller and vertically aligned upper roller 171 are connected by a belt drive in the same manner as rollers 170 and 180 and with the same drive reduction. Rollers 181and 171 therefore rotate in the clockwise direction.

From the foregoing, it will be understood that the roller modules are paired horizontally for grinding purposes but vertically for drive purposes. This permits a simple, easily serviced and inexpensive drive mechanism, automatic maintenance of the speed differential between the rollers and an automatic balancing of the working load between the rollers.

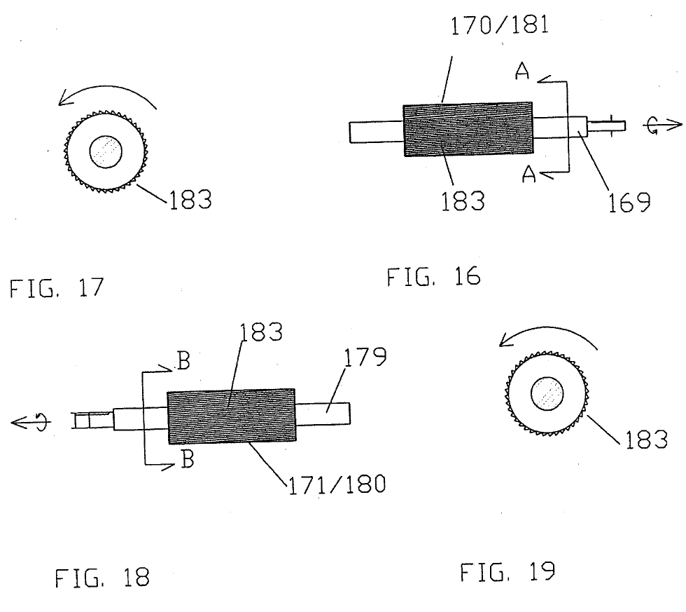

The rollers themselves are ideally made of stainless steel and in an embodiment constructed by the applicant, are 30″ long and 12″ in diameter. Corrugations or grinding nodules are formed or machined into the surface of each roller and their shape and configuration may vary depending upon roller placement, the type of rubber being ground, and the desired characteristics of the end product. The corrugations on a typical fast roller are shown in FIGS. 16 and 17, and those on a typical slow roller are shown in FIGS. 18 and 19.

The corrugations 183 on both sets of rollers spiral slightly in the longitudinal direction of each roller at the rate of ½″ per foot (left hand). For upper fast roller 170, the corrugation pitch is 22 and on lower fast roller 181, it is 36. Similarly, the pitch of the corrugations on upper slow roller 171 is 22 and on lower slow roller 180, it is 36. The corrugations are cut in the Allis Dull profile that will be known to machinists.

After grinding between upper rollers 170 and 171, the crumb falls through chute 185 and into the lower grinding module for processing between rollers 180 and 181.

Nitrogen gas from insulated line 158 discharges into chute 185 (FIG. 12) to cool the crumb that's been warmed somewhat as a result of processing in the upper roller pair. Following grinding, the crumb is discharged into chute 186 beneath the lower roller pair and is transported in the direction of arrow N (FIG. 14) by sealed auger 191 to hammermill 200 (a PULVA “D”). Auger 191 is a sealed unit ideally made of stainless steel and is adapted for operation under cryogenic conditions. The hammermill is also ideally a stainless steel construction and is similarly adapted for maximum efficiency when processing cryogenically-treated materials. Nitrogen gas from inside the grinding module discharges through insulated duct 159 into feed chute 188 leading into the hammermill for additional post-cooling of the crumb. The hammermill typically operates under negative pressure to draw the nitrogen gas in the grinding units into duct 159.

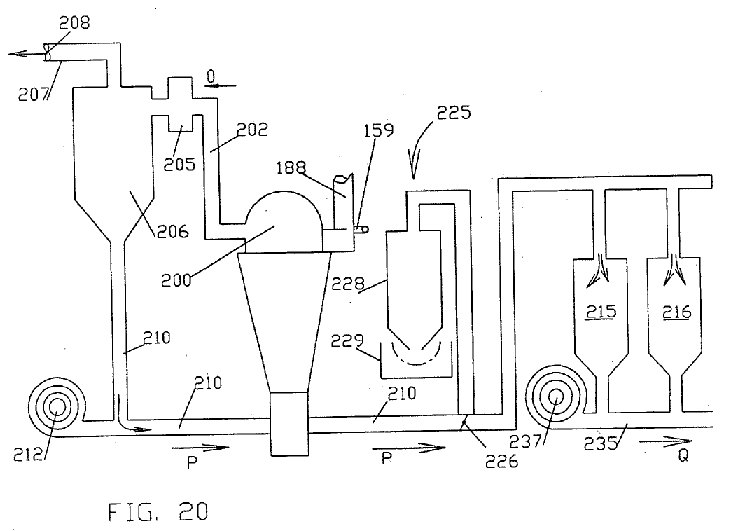

With reference to FIG. 20, there are two discharges from the hammermill. The first is an exhaust duct 202 connected to a suction blower 205 that draws the nitrogen gas and suspended fine rubber from the hammermill's interior for transport in the direction of arrow O. Duct 202 discharges into cyclone 206 where the rubber falls out and discharges through the cyclone's lower end into pneumatic conveyor 210 where it is blown in the direction of arrow P by blower 212. The extracted nitrogen gas is itself exhausted to atmosphere through duct 207 which includes an exhaust fan 208 at its outlet.

The second discharge from the hammermill is of course from its lower end where the processed crumb is delivered into pneumatic duct 210 where it joins the rubber from duct 202 for transport in the direction of arrow P to storage bins 215 and 216 (FIG. 10). The air flow in conveyor 210 is dissipated in the usual way through bag manifold 218.

As will now be described, the crumb from bins 215 and 216 is delivered to a classification section which cuts the rubber into different-sized fractions for bagging/storage. If unclassified rubber is required, the present system can include a bagging station 225 which taps into pneumatic conveyor 210 prior to the storage bins as shown most clearly in FIG. 10. A gate valve 226 directs some or all of the flow from the conveyor into cyclone 228 where the rubber falls out for collection into a bag (not shown) suspended from a bag stand 229. The air flow from the cyclone is dissipated through a communicating bag manifold 230.

For the most part, however, recyclers want classified crumb and the rubber from bins 215 and 216 is therefore separated into fractions in the following manner.

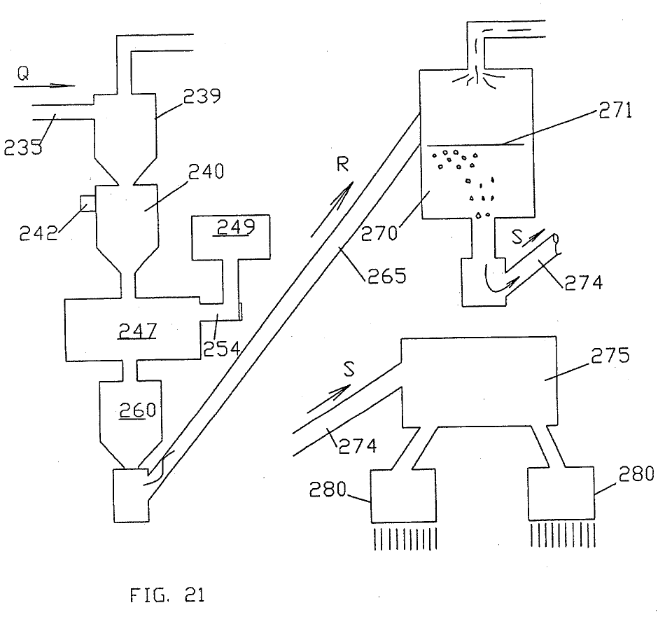

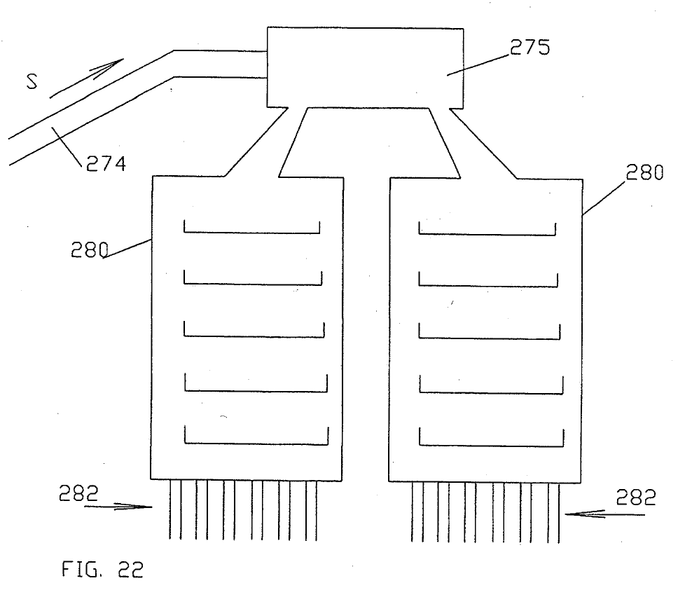

Reference will be made to FIG. 21 for better understanding of this part of the process.

Crumb from bins 215 and 216 discharges into pneumatic conveyor 235 in which it's blown in the direction of arrow Q by blower 237. The crumb discharges into an elevated hopper 240 through another cyclone 239. The hopper includes a level control 242 that can deactivate blower 237 to prevent the hopper's overfilling. When full, the hopper can hold up to 1,000 pounds of crumb.

Hopper 240 discharges the crumb at a controlled metered rate into a mixing chamber 247 where the crumb is mixed with a “flow agent” that the applicant has discovered allows the crumb to be sifted into some ultrafine mesh fractions. One flow agent discovered by the applicant to be effective is carbon black available from Cabot Corporation, product No. N990 or N234. The carbon black is stored in a reservoir 249 and is discharged into the mixing chamber via a metering auger 254. Inside the mixer, a revolving blade or other stirring tool (not shown) rotates at approximately 150 rpm to mix the crumb and the flow agent together for approximately five minutes. The amount of flow agent typically varies in the range of from approximately 0.25% to 2% by volume of the mixture depending upon requirements, for example the separation particularly of ultrafine fractions (−100 mesh).

After mixing, the crumb discharges from the mixer into a batch bin 260 that in turn discharges into an auger 265 for transport of the crumb in the direction of arrow R into a second KASON classifier 270. The classifier can be set up to itself separate the crumb into different sized fractions and to discharge these fractions through separate outlets for bagging or additional sorting, but more typically, it will include a single screen that allows all of the rubber to pass while scalping off remaining fiber and fiber balls for disposal. The rubber discharges from the classifier's lower end into an auger 274 for transport of the crumb in the direction of arrow S into a divider manifold 275.

The manifold divides the crumb into two equal streams for delivery to a pair of sifters 280. The sifters used by the applicant are essentially wooden boxes that support a column of screens. They are commercially available units from Great Western Manufacturing Company, model no. HS2X27, and are shown schematically in FIG. 22.

As shown, each sifter includes five screens varying in mesh size from top to bottom from 30, 40, 60, 80 and 100 mesh. This produces crumb fractions of +30 mesh, 30-40 mesh, 40-60 mesh, 60-80 mesh, 80-100 mesh, and −100 mesh. The sifters each have a manifold 282 for the separate discharge of each of these fractions. This allows each of the fractions to be handled and distributed in different ways.

For example, and with reference to FIG. 10, two of the fractions (typically those highest in volume) discharge into pneumatic conveyors 288 and 289 for delivery to storage bins 291 and 292, respectively. Augers 295, 296 and 297 are connected to three of the manifold's remaining discharges for transport of the fractions in question to respective bagging stations 298, 299 and 300. The final fraction, typically the finest (−100 mesh), discharges into pneumatic conveyor 305 for delivery to station 310 where the crumb can be bagged directly, or discharged into a fine-mesh sifter for additional classification into even finer fractions as low as −200 mesh. Some or all of the discharges from the sifters can incorporate final screens to remove additional remaining fiber.

The use of the screen sizes mentioned above, the fractions they produce, and indeed the number of screens, are all variable in response to customer requirements.

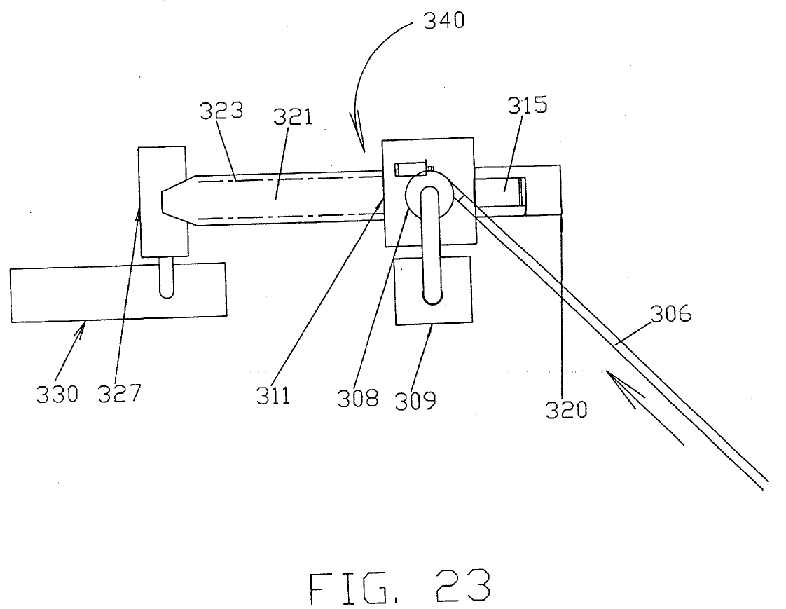

In an embodiment constructed by the applicant, the 40-60 and 60-80 mesh fractions are delivered to storage bins 291 and 292, and the remaining fractions are delivered directly to bagging stations where the fractions are received into large, reusable sack-like bags that include drawstring closures. The crumb from bins 291 and 292 is delivered to a bagging station 340 where the rubber is packaged into sealed plastic bags. Bagging station 340 will now be described with reference to FIG. 23.

Crumb from either of bins 291 and 292 is selectively discharged into pneumatic conveyor 305 for transport into cyclone 308. The crumb discharges from the cyclone into hopper 310. The airflow into the cyclone is dissipated through bag manifold 309.

The crumb from the hopper discharges into auger 315 which meters the flow of the crumb onto inclined vibrating table 320. The vibrator includes an upper screen 321 that allows the rubber to fall through but which collects and then discharges remaining fiber and fiber balls off the end of the screen where it's collected into bins or bags for disposal. The rubber falling through the screen lands on a lower deck 323 that discharges its load into a bagging machine 327. Bagger 327 fills bags (usually polymer bags) ranging in size typically from 10 to 20 kilograms, heat seals the bags and discharges them onto a bagging conveyor 330 which removes the bags for storage prior to shipment. The bagger will typically include a built-in scale in and such electronic controls as are known in the art. The bagger and sealer used by the applicant are commercially available from Bonar Packaging. The bagging station may also include a magnetic separator for removing residual metal if this is required or desired.

The above-described embodiments of the present invention are meant to be illustrative of preferred embodiments of the present invention and are not intended to limit the scope of the present invention. Various modifications, which would be readily apparent to one skilled in the art, are intended to be within the scope of the present invention. The only limitations to the scope of the present invention are set out in the following appended claims.

1. A method for breaking down pieces of material into smaller pieces and for separating out different substances making up said material, one of said substances being a fibrous textile and another being metal, comprising the steps of:
subjecting said pieces to a series of dismemberments to produce progressively smaller pieces falling within a predetermined size range;
separating said smaller pieces into a plurality of fractions, each fraction including pieces within a predetermined size range; and
subjecting each said fraction to a flow of air calibrated to cause separation of said fibrous textile material from said pieces.

2. The method of claim 1 wherein said dismembered pieces are exposed to one or more magnets to remove said metal.

3. The method of claim 2 wherein said pieces are subjected to at least one vibratory screening for separation of said pieces from said fibrous textile.

4. The method of claim 3 wherein said step of subjecting each said fraction to a flow of air occurs after said at least one vibratory screening, and the fibrous textile removed by said flow of air is returned to said at least one vibratory screening and added to said material being screened.

5. The method of claim 4 wherein said fractions subjected to said flow of air are discharged onto vibrating air table means that are at least partially enclosed a within housing means, said fractions there being subjected to a flow of updraft air at a rate causing additional separation of said fibrous textile from said fractions.

6. The method of claim 5 wherein said pieces are subjected to at least three vibratory screenings for separation of said fibrous textile material.

7. The method of claim 6 wherein in at least one of said vibratory screenings, said pieces are divided into undersize and oversize pieces, said oversize pieces being returned for additional dismemberment until said pieces are undersized.

8. The method of claim 7 wherein said pieces of material are used tires or pieces of said tires, said metal is wire and said fibrous textile consists of cord.

9. Apparatus for processing a feedstock consisting of a first material comprising particles of different sizes mixed with a second lighter material to be separated from said first material, comprising:
means for separating said feedstock into two or more fractions, each said fraction including particles of said first material falling within a predetermined size range;
an enclosure for receiving one of each said fractions in a stream passing therethrough;
ventilator means causing a flow of air to intersect said stream of particles in said enclosure; and
means for adjusting the flow rate of said air having regard to said size range of said particles, wherein said airflow carries away some or all of said second material for separation from said first material.

10. The apparatus of claim 9 further including air table means having an upper surface and adapted for the flow of air in an upwards direction therethrough, said fractions of particulates being discharged from respective ones of said enclosures onto said upper surface wherein said flow of air separates out additional of said second material from said first material for removal.

11. The apparatus of claim 10 wherein said upper surface is divided into segments, each said segment receiving a respective one of said fractions.

12. The apparatus of claim 11 wherein said upward flow of air through each of said segments is adjusted having regard to the size of said particles in said segment.

13. The apparatus of claim 12 wherein said air table means are vibratory for agitation of said particles on said upper surface thereof.

14. The apparatus of claim 13 wherein said means for adjusting comprise at least one damper pivotally disposed in said enclosure and being adjustable to increase or decrease said flow of air intersecting said stream of particles.

15. The apparatus of claim 14 wherein said ventilator means comprise a suction blower for drawing air into said enclosure, through said stream of particles and out of said enclosure with said second material entrained in said air flowing out of said enclosure.

16. The apparatus of claim 15 wherein said air table is disposed within a housing, said housing including an outlet in fluid communication with means drawing air out of said housing, said air having entrained therein said second material separated from said first material by said upward flow of air through said air table.

17. The apparatus of claim 16 wherein said first material is crumb rubber and said second material is a fibrous textile.

18. A method of treating a particulate material cryogenically to produce smaller particles, comprising the steps of:
cooling said material to cryogenic temperatures;
feeding said cooled material at a predetermined rate between at least one pair of closely spaced, counter-rotating rollers for reducing the size of said particles, one roller of said pair rotating at a first predetermined speed, and the second of said rollers rotating at a second higher predetermined speed; and
thereafter subjecting said material to hammering for producing yet smaller particles.

19. The method of claim 18 wherein said cooled material is fed between at least two pairs of said rollers.

20. The method of claim 19 wherein said at least two pairs of rollers are arranged in vertical alignment with said first pair being disposed above said second pair.

21. The method of claim 20 wherein cryogenic gas is added as said material passes through said pairs of rollers for additional cooling of said material during treatment between said pairs of rollers.

22. The method of claim 21 wherein the speed differential between the rollers of each said pair thereof is in the range of 10:1.

23. The method of claim 21 wherein the speed differential is 3 to 4:1 and is preferably 3.29:1.

24. The method of claim 21 wherein cryogenic gas is added to said material during said hammering thereof.

25. The method of claim 24 wherein said cooling of said material comprises the steps of first pre-cooling said material using cryogenic gas and then cooling said material by submersion in a cryogenic liquid.

26. The method of claim 25 wherein said material is crumb rubber, said cryogenic gas is nitrogen gas and said cryogenic liquid is liquid nitrogen.

27. Apparatus for treating a particulate material cryogenically to produce smaller particles, comprising:
freezer means wherein said material is cooled to cryogenic temperatures;
at least a first pair of closely spaced apart, counter-rotating rollers sealed in a housing for receiving said cooled material therebetween for a first reduction in the size of said particles;
means for driving each roller of said pair at a selected, predetermined rotational speed; and
means for receiving and storing said material following said cryogenic treatment thereof between said rollers.

28. The apparatus of claim 27 further comprising a second pair of closely spaced counter-rotating rollers sealed in a housing for receiving therebetween said material from said first pair of rollers for a second reduction in the size of said particles, and means for driving each roller of said second pair at a selected, predetermined rotational speed.

29. The apparatus of claim 28 wherein said rollers are spaced apart by a small gap of adjustable width selected to cause a reduction in the size of said particles.

30. The apparatus of claim 29 further comprising hammering means for receiving therein said material from either or both of said first and second pairs of rollers for a third reduction in the size of said particles.

31. The apparatus of claim 30 wherein one roller of each of said first and second pair of rollers is driven by said drive means at a first predetermined rotational speed, and the second roller of each of said first and second pair is driven by said drive means at a second higher predetermined speed.

32. The apparatus of claim 31 wherein the speed differential between said rollers of each said pair thereof is in the range of 10:1 to 1.1:1.

33. The apparatus of claim 31 wherein said speed differential is 3 or 4:1 and is preferably 3.29:1.

34. The apparatus of claim 33 wherein said first pair of rollers is arranged above said second pair of rollers in parallel, vertical alignment therewith, the vertically aligned rollers to one side of said gap being connected by a drive member for rotation in one direction, and the vertically aligned rollers to the other side of said gap being connected by another drive member for rotation in the opposite direction, wherein said particles are drawn into, between and through said gap between each of said pairs of rollers, each said drive member being operationally connected to a prime mover for rotation of said rollers.

35. The apparatus of claim 34 wherein said drive means are arranged so that the diagonally opposite rollers of each of said first and second pairs are driven at substantially the same rotational speed.

36. The apparatus of claim 35 wherein said predetermined speed is approximately 700 rpm, and said second higher predetermined speed is approximately 2300 rpm.

37. The apparatus of claim 36 wherein said gap between said rollers is adjustably maintained in the range from 0.001″ to 0.01″, and preferably in the range from 0.002″ to 0.007″.

38. The apparatus of claim 37 wherein said gap is independently adjustable from either end of said rollers to be the same or variable in width along its length between said rollers.

39. The apparatus of claim 38 wherein the surface of each roller is textured to facilitate treatment of said particulates.

40. The apparatus of claim 39 wherein the surface of each roller includes spirally arranged longitudinally extending corrugations spaced apart at a predetermined pitch.

41. The apparatus of claim 40 wherein said corrugations spiral at the rate of ½″ per foot, the pitch of said corrugations being selectable in the range between 22 and 36.

42. The apparatus of claim 41 wherein the profile of said corrugations is Allis Dull.

43. The apparatus of claim 42 wherein said freezer means are partially filled with cryogenic liquid whereby some of said particulates are submerged below the level of said liquid for cooling and some are disposed above said liquid for pre-cooling by the vaporized gas from said cryogenic liquid.

44. The apparatus of claim 43 wherein said cryogenic gas from said freezer means is discharged into said housings for said roller means for additional cooling of said particulates during treatment therein.

45. The apparatus of claim 44 wherein cryogenic gas from said housings is discharged into said hammering means for additional cooling of said particulates during treatment therein.

46. The apparatus of claim 45 wherein rotation of the rollers of either or both of said first and second pairs thereof at different rotational speeds promotes both grinding and shearing of the particles to reduce their size.

47. The apparatus of claim 27 wherein said particulate material is crumb rubber.

48. A method of sorting a material into separate fractions, each fraction including particulates of said material falling within a predetermined size range, comprising the steps of:
adding a flow agent to said material and mixing said material and said flow agent together, said flow agent being selected to increase the recovery of the smallest particles of said material;
sorting said material through a plurality of screens to cut said material into said fractions; and
collecting said fractions for packaging or storage.

49. The method of claim 48 wherein said flow agent is carbon black.

50. The method of claim 49 wherein said carbon black is Cabot Corporation carbon black product Nos. N990 or N234, or carbon black having characteristics similar thereto.

51. The method of claim 50 wherein said carbon black is added to said material in an amount from approximately 0.25% to about 2% by volume of said mixture.

52. The method of claim 51 wherein said material is crumb rubber and said carbon black increases the recovery of crumb rubber particles smaller than 100 mesh.
